(19) United States
(12) Patent Application Publication
(10) Pub. No.: US 2015/0185968 A1
(43) Pub. Date: Jul. 2, 2015

(54) METHOD FOR DISPLAYING AND AN ELECTRONIC DEVICE THEREOF

(71) Applicant: Samsung Electronics Co., Ltd., Gyeonggi-do (KR)

(72) Inventors: Hoi-Taek Kim, Gyeonggi-do (KR); Sin-Won Kang, Gyeonggi-do (KR); Eung-Kwun Kim, Seoul (KR); Chan-Woo Park, Gyeonggi-do (KR); Ki-Won Lee, Gyeonggi-do (KR)

(21) Appl. No.: 14/583,094

(22) Filed: Dec. 24, 2014

(30) Foreign Application Priority Data
Dec. 27, 2013 (KR) 10-2013-0165711

(51) Int. Cl. G06F 3/0481; G06F 3/0484

(52) U.S. Cl. CPC G06F 3/0481; G06F 3/0484

(57) ABSTRACT

According to various exemplary embodiments, a screen output method performed in an electronic device may include detecting a transformation of the electronic device. The screen output method also includes detecting a transformation of the electronic device. The screen output method also includes if the transformation satisfies a pre-defined condition, controlling an output screen. Other exemplary embodiments are also possible.

### PRIORITY

The present application is related to and claims the benefit under 35 U.S.C. §119(a) of a Korean patent application filed in the Korean Intellectual Property Office on Dec. 27, 2013, and assigned Serial No. 10-2013-0165711, the entire disclosure of which is hereby incorporated by reference.

### TECHNICAL FIELD

Various exemplary embodiments relate to a screen output method of an electronic device.

### BACKGROUND

Electronic devices having a convergence function of complexly performing one or more functions have been increased in number in recent years. Further, a mobile terminal which is represented as so-called a ‘smart phone’ is mainly used as the electronic devices. The mobile terminal has a touch-type display module with a large-sized screen, and has a high-definition camera module and thus can capture a still picture and a moving picture, in addition to a function such as communication. Further, the mobile terminal can play multimedia content such as a music, a video, and the like, and can access a network to perform web surfing. By employing a high-performance processor, the mobile terminal has been gradually evolved to perform various convergence functions.

A touch screen which is recently used in an electronic device in various manners can input and display information in one screen, which results in an increase in a size of the touch screen.

In general, the electronic device can output various types of screens in an area called a window.

### SUMMARY

To address the above-discussed deficiencies, it is a primary object to provide an electronic device according to various exemplary embodiments of the present disclosure that may control an output screen by detecting a screen transformation for a screen control, for example, by detecting that a display is transformed and thereafter is restored to an original shape.

According to one exemplary embodiment for solving the aforementioned problem or other problems, a screen output method may include controlling an output screen in an electronic device if a screen transformation for a screen control of the electronic device satisfies a pre-defined condition.

According to various exemplary embodiments, an electronic device may include a display unit for outputting a screen. The electronic device also includes a transformation detection module for detecting a screen transformation for a screen control of the electronic device. The electronic device also includes at least one processor. According to one exemplary embodiment, the processor may be configured for, upon detection of the screen transformation for the screen control of the electronic device in a state where a screen having a first size is output, outputting the previously output screen having the first size by changing the screen size from the first size to a second size.

According to various exemplary embodiments, a computer readable recording medium may store program code that, when executed by at least one processor, causes an electronic device to detect a screen transformation of an electronic device. The program code also causes the electronic device to, if the transformation satisfies a pre-defined condition, control an output screen.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a network environment including an electronic device according to various exemplary embodiments;

FIG. 2 illustrates a block diagram of a screen control module according to various exemplary embodiments of the present disclosure;

FIG. 3 illustrates a process of an electronic device according to various exemplary embodiments of the present disclosure;

FIG. 4 illustrates a process of an output screen control operation of an electronic device according to various exemplary embodiments of the present disclosure;

FIG. 5 illustrates an operation of controlling an output screen in an electronic device according to various exemplary embodiments of the present disclosure;

FIG. 6 illustrates an operation of controlling an output screen in an electronic device according to various exemplary embodiments of the present disclosure;

FIG. 7 illustrates a process of an output screen control operation of an electronic device according to various exemplary embodiments of the present disclosure;

FIG. 8 illustrates an operation of controlling an output screen in an electronic device according to various exemplary embodiments of the present disclosure;

FIG. 9 illustrates an operation of controlling an output screen in an electronic device according to various exemplary embodiments of the present disclosure;

FIG. 10 illustrates an operation of controlling an output screen in an electronic device according to various exemplary embodiments of the present disclosure;

FIG. 11 illustrates a process of a screen control operation of an electronic device according to various exemplary embodiments of the present disclosure;

FIGS. 12A-12B illustrate operations of controlling an output screen in an electronic device according to various exemplary embodiments of the present disclosure;

FIG. 13 illustrates an electronic device according to various exemplary embodiments of the present disclosure; and

FIG. 14 illustrates a block diagram of an electronic device according to various exemplary embodiments.

### DETAILED DESCRIPTION

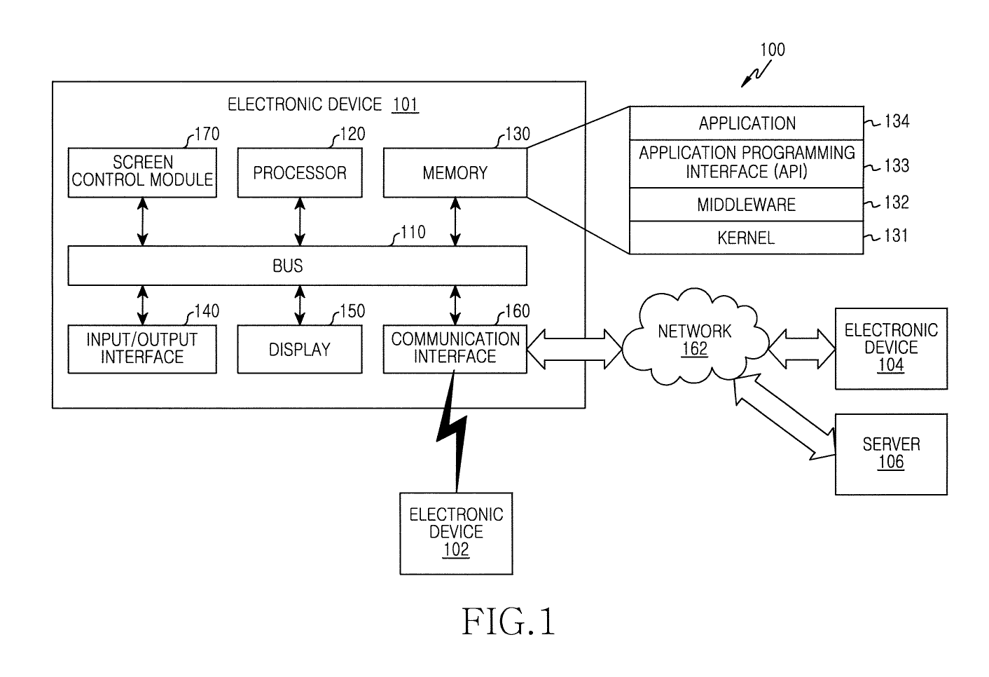

FIGS. 1 through 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system and method. Hereinafter, the present disclosure is described with reference to the accompanying drawings. While the present disclosure is susceptible to various modifications and alternative forms, a specific embodiment thereof has been shown by way of example in the drawings and will herein be described in detail. It should be understood, however, that it is not intended to limit the present disclosure to the particular form disclosed, but, alternatively, the present disclosure is to cover all modifications, equivalents, and alternatives falling within the spirit and scope of the present disclosure as defined by the appended claims. Like reference numerals denote like constitutional elements throughout the drawings.

The expression “include” or “may include” used in the present disclosure is intended to indicate a presence of a corresponding function, operation, or constitutional element, and it is not intended to limit a presence of one or more functions, operations, or constitutional elements. In addition, in the present disclosure, the term “include” or “have” is intended to indicate that characteristics, numbers, steps, operations, constitutional elements, and components disclosed in the specification or combinations thereof exist. As such, the term “include” or “have” should be understood that there are additional possibilities of one or more other characteristics, numbers, steps, operations, constitutional elements, elements or combinations thereof.

In the present disclosure, an expression “or” includes any and all combinations of words enumerated together. For example, “A or B” may include A or B, or may include both A and B.

Although expressions such as “1^{st}”, “2^{nd}”, “first”, “second” may be used to express various constitutional elements of the present disclosure, it is not intended to limit the corresponding constitutional elements. For example, the above expressions are not intended to limit an order or an importance of the corresponding constitutional elements. The above expressions may be used to distinguish one constitutional element from another constitutional element. For example, a 1^{st} user device and a 2^{nd} user device are both user devices, and indicate different user devices. For example, a 1^{st} constitutional element may be termed a 2^{nd} constitutional element, and similarly, the 2^{nd} constitutional element may be termed the 1^{st} constitutional element without departing from the scope of the present disclosure.

When a constitutional element is mentioned as being “connected” to or “accessing” another constitutional element, this may mean that it is directly connected to or accessing the other constitutional element, but it is to be understood that there are no intervening constitutional elements present. Alternatively, when a constitutional element is mentioned as being “directly connected” to or “directly accessing” another constitutional element, it is to be understood that there are no intervening constitutional elements present.

The terminology used in the present disclosure is for the purpose of describing particular exemplary embodiments only and is not intended to be limiting of the present disclosure. A singular expression includes a plural expression unless there is a contextually distinctive difference therebetween.

Unless otherwise defined, all terms (including technical and scientific terms) used herein have the same meaning as commonly understood by those ordinarily skilled in the art to which the present disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

An electronic device according to the present disclosure may be a device including a communication function. For example, the electronic device may include at least one of a smart phone, a tablet Personal Computer (PC), a mobile phone, a video phone, an e-book reader, a desktop PC, a laptop PC, a netbook computer, a Personal Digital Assistant (PDA), a Portable Multimedia Player (PMP), a MPEG-1 Audio Layer 3 (MP3) player, a mobile medical device, a camera, and a wearable device (e.g., a Head-Mounted-Device (HMD) such as electronic glasses, electronic clothes, an electronic bracelet, an electronic necklace, an electronic appcessory, an electronic tattoo, or a smart watch).

According to certain exemplary embodiments, the electronic device may be a smart home appliance having a communication function. For example, the smart home appliance may include at least one of a TeleVision (TV), a Digital Video Disk (DVD) player, an audio, a refrigerator, an air conditioner, a cleaner, an oven, a microwave oven, a washing machine, an air purifier, a set-top box, a TV box (e.g., Samsung HomeSync™, Apple TV™, or Google TV™), a game console, an electronic dictionary, an electronic key, a camcorder, and an electronic picture frame.

According to certain exemplary embodiments, the electronic device may include at least one of various medical devices (e.g., Magnetic Resonance Angiography (MRA), Magnetic Resonance Imaging (MRI), Computed Tomography (CT), imaging equipment, ultrasonic instrument, and the like), a navigation device, a Global Positioning System (GPS) receiver, an Event Data Recorder (EDR), a Flight Data Recorder (FDR), a car infotainment device, an electronic equipment for ship (e.g., a vessel navigation device, a gyro compass, and the like), avionics, a security device, and an industrial or domestic robot.

According to certain exemplary embodiments, the electronic device may include at least one of furniture or a part of building/constructions including a screen output function, an electronic board, an electronic signature receiving device, a projector, and various measurement machines (e.g., water supply, electricity, gas, propagation measurement machine, and the like). The electronic device according to the present disclosure may be one or more combinations of the aforementioned various devices. In addition, it is apparent those ordinarily skilled in the art that the electronic device according to the present disclosure is not limited to the aforementioned devices.

According to one exemplary embodiment, the electronic device may include a plurality of displays capable of a screen output, and may output one screen by using the plurality of displays as one display or may output a screen to each display. According to one exemplary embodiment, the plurality of displays may be connected with a connection portion, for example, a hinge, to be movable in a specific angle such according to a fold-in or fold-out manner.

According to another exemplary embodiment, the electronic device may include a flexible display, and may output a screen by using the flexible display as one display or by dividing a display area into a plurality of parts with respect to a portion of the flexible display.

According to another exemplary embodiment, the electronic device may be equipped with a cover having a display protection function capable of a screen output. According to one exemplary embodiment, the electronic device may output one screen by using a display of the cover and a display of the electronic device as one display or may output a screen to each display.

Hereinafter, an electronic device according to various exemplary embodiments will be described with reference to the accompanying drawings. The term ‘user’ used in the various exemplary embodiments may refer to a person who uses the electronic device or a device (e.g., an Artificial Intelligence (AI) electronic device) which uses the electronic device.

FIG. 1 illustrates a network environment 100 including an electronic device 101 according to various exemplary embodiments. Referring to FIG. 1, the electronic device 101 may include a bus 110, a processor 120, a memory 130, an input/output interface 140, a display 150, a communication interface 160, and a screen control module 170.

The bus 110 may be a circuit for connecting the aforementioned constitutional elements to each other and for delivering communication (e.g., a control message) between the aforementioned constitutional elements.

The processor 120 may receive an instruction from the aforementioned different constitutional elements (e.g., the memory 130, the input/output interface 140, the display 150, the communication interface 160, or the screen control module 170), for example, via the bus 110, and thus may interpret the received instruction and execute arithmetic or data processing according to the interpreted instruction.

The memory 130 may store an instruction or data received from the processor 120 or different constitutional elements (e.g., the input/output interface 140, the display 150, the communication interface 160, or the screen control module 170) or generated by the processor 120 or the different constitutional elements. The memory 130 may include programming modules such as a kernel 131, a middleware 132, an Application Programming Interface (API) 133, an application 134, and the like. Each of the aforementioned programming modules may consist of software, firmware, or hardware entities or may consist of at least two or more combinations thereof.

The kernel 131 may control or manage the remaining other programming modules, for example, system resources (e.g., the bus 110, the processor 120, the memory 130, and the like) used to execute an operation or function implemented in the middleware 132, the API 133, or the application 134. In addition, the kernel 131 may provide a controllable or manageable interface by accessing individual constitutional elements of the electronic device 101 in the middleware 132, the API 133, or the application 134.

The middleware 132 may perform a mediation role such that the API 133 or the application 134 communicates with the kernel 131 to exchange data. In addition, regarding task requests received from the application 134, for example, the middleware 132 may perform a control (e.g., scheduling or load balancing) for the task requests by using a method of assigning a priority capable of using a system resource (e.g., the bus 110, the processor 120, the memory 130, and the like) of the electronic device 101 to at least one of the applications 134.

The API 133 may include at least one interface or function (e.g., instruction) for file control, window control, video processing, character control, and the like, as an interface capable of controlling a function provided by the application 134 in the kernel 131 or the middleware 132.

According to various exemplary embodiments, the application 134 may include a Short Message Service (SMS)/Multimedia Messaging Service (MMS) application, an e-mail application, a calendar application, an alarm application, a health care application (e.g., an application for measuring a physical activity level, a blood sugar, and the like) or an environment information application (e.g., atmospheric pressure, humidity, or temperature information). Additionally or alternatively, the application 134 may be an application related to an information exchange between the electronic device 101 and an external electronic device (e.g., an electronic device 104). The application related to the information exchange may include, for example, a notification relay application for relaying specific information to the external electronic device or a device management application for managing the external electronic device.

For example, the notification relay application may include a function of relaying notification information generated in another application (e.g., an SMS/MMS application, an e-mail application, a health care application, an environment information application, and the like) of the electronic device 101 to the external electronic device (e.g., the electronic device 104). Additionally or alternatively, the notification relay application may receive notification information, for example, from the external electronic device (e.g., the electronic device 104) and may provide it to the user. The device management application may manage, for example, a function for at least one part of the external electronic device (e.g., the electronic device 104) which communicates with the electronic device 101. Examples of the function include turning on/turning off the external electronic device itself (or some components thereof) or adjusting of a display illumination (or a resolution), and managing (e.g., installing, deleting, or updating) of an application which operates in the external electronic device or a service (e.g., a call service or a message service) provided by the external electronic device.

According to various exemplary embodiments, the application 134 may include an application specified according to attribute information (e.g., an electronic device type) of the external electronic device (e.g., the electronic device 104). For example, if the external electronic device is an MP3 player, the application 134 may include an application related to a music play. Similarly, if the external electronic device is a mobile medical device, the application 134 may include an application related to a health care. According to one exemplary embodiment, the application 134 may include at least one of a specified application in the electronic device 101 or an application received from the external electronic device (e.g., a server 106 or the electronic device 104).

The input/output interface 140 may relay an instruction or data input from a user via an input/output device (e.g., a sensor, a keyboard, or a touch screen) to the processor 120, the memory 130, the communication interface 160, or the screen control module 170, for example, via the bus 110. For example, the input/output interface 140 may provide data regarding a user's touch input via the touch screen to the processor 120. In addition, the input/output interface 140 may output an instruction or data received from the processor 120, the memory 130, the communication interface 160, or the screen control module 170 to an output device (e.g., a speaker or a display), for example, via the bus 110. For example, the input/output interface 140 may output audio data provided by using the processor 120 to the user via the speaker.

The display 150 may display a variety of information (e.g., multimedia data or text data) to the user.

The communication interface 160 may connect a communication between the electronic device 101 and an external device (e.g., the electronic device 102 or 104, or the server 106). For example, the communication interface 160 may communicate with the external device by being connected with a network 162 through wireless communication or wired communication. For example, the wireless communication may include at least one of Wireless Fidelity (Wi-Fi), Bluetooth (BT), Near Field Communication (NFC), a Global Positioning System (GPS), and cellular communication (e.g., LTE, LTE-A, CDMA, WCDMA, UMTS, WiBro, GSM, and the like). For example, the wired communication may include at least one of Universal Serial Bus (USB), High Definition Multimedia Interface (HDMI), Recommended Standard (RS)-232, and Plain Old Telephone Service (POTS).

According to one exemplary embodiment, the network 162 may be a telecommunications network. The telecommunications network may include at least one of a computer network, an internet, an internet of things, and a telephone network. According to one exemplary embodiment, a protocol (e.g., a transport layer protocol, a data link layer protocol, or a physical layer protocol) for a communication between the electronic device 101 and the external device may be supported in at least one of the application 134, the API 133, the middleware 132, the kernel 131, and the communication interface 160.

According to one exemplary embodiment, the screen control module 170 may control an output screen by detecting a screen transformation for a screen control of the electronic device, for example, by detecting that a display is transformed and thereafter is restored to an original shape.

For example, upon detection of a transformation and restoration of a display which satisfies a screen control condition, the screen control module 170 may process an operation of changing a size of an output screen, restoring the changed size of the output screen, changing an output order for a plurality of output screens, outputting a sub screen for the output screen, and the like.

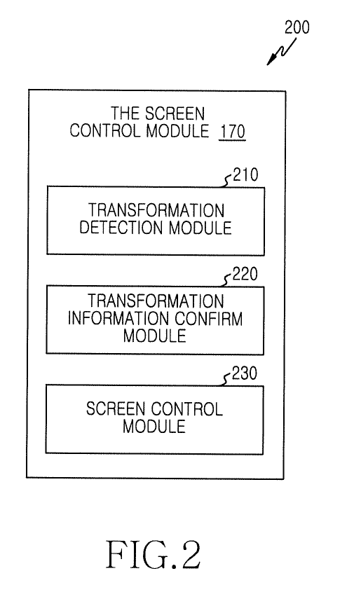

FIG. 2 illustrates a block diagram of a screen control module according to various exemplary embodiments of the present disclosure.

The screen control module 170 may include a transformation detection module 210, a transformation information confirm module 220, and a screen control module 230.

The transformation detection module 210 may detect a transformation for a display of the electronic device. Examples of the transformation include increasing, decreasing, bending, folding-in, folding-out, twisting, curving, unfolding, and the like. According to one exemplary embodiment, the transformation detection module 210 may detect a transformation for a plurality of displays, a flexible display, and the like coupled through a connection portion. According to one exemplary embodiment, the transformation detection module 210 may include a sensor module capable of detecting the transformation for the display.

The transformation information confirm module 220 may confirm a transformation point and a transformation degree (e.g., an angle of folding-in, folding-out, and the like) of the display of the electronic device. According to one exemplary embodiment, the transformation information confirm module 220 may determine a size, output position, and the like of the output screen on the basis of the transformation position of the display, and may determine a control point of the output screen on the basis of the transformation degree of the display.

The screen control module 230 may change a configuration of the output screen on the basis of information confirmed by the transformation information confirm module 220. The changing of the configuration of the output screen may include changing the size of the output screen, restoring the changed size of the output screen, changing an output order for a plurality of output screens, outputting a sub screen for the output screen, and the like.

According to various exemplary embodiments, a screen output apparatus may include a display unit for outputting a screen in an electronic device, a transformation detection module for detecting a screen transformation for a screen control of the electronic device, and at least one processor. Upon detection of the screen transformation for the screen control of the electronic device in a state where a screen having a first size is output, the processor may output the previously output screen having the first size by changing the screen size from the first size to a second size.

According to various exemplary embodiments, upon detection of the screen transformation for the screen control of the electronic device in a state where the screen of which a size is changed to the second size is output, the processor may output the previously output screen having the second size by changing the screen size to the first size.

According to various exemplary embodiments, upon detection of the screen transformation for the screen control of the electronic device in a state where a plurality of screens are output, the processor may confirm a priority for an output screen, and may change a size of a screen corresponding to the priority.

According to various exemplary embodiments, the processor may confirm at least one of a user input, a screen output order, and a screen arrangement state (position) as the priority.

According to various exemplary embodiments, the transformation detection module may detect the screen transformation for the screen control of the electronic device on the basis of at least one of a transformation point and a transformation degree.

According to various exemplary embodiments, the processor may output a sub screen constituting an output screen after changing a size of the screen.

According to various exemplary embodiments, the display unit may include a flexible display. The transformation detection module may detect a transformation of the flexible display for the screen control.

According to various exemplary embodiments, the display unit may include a plurality of displays connected through a connection portion. The transformation detection module may detect a movement for the display.

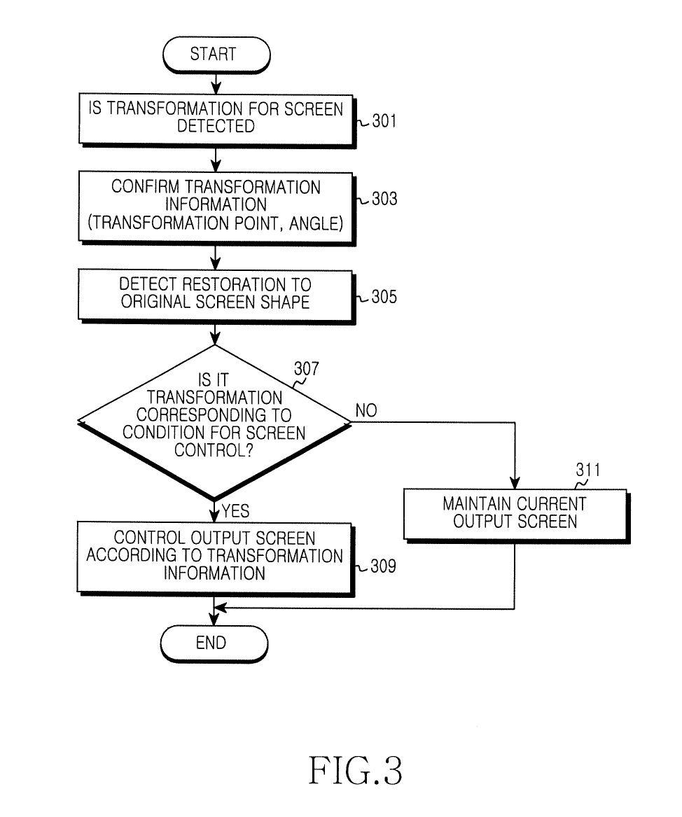

FIG. 3 illustrates a process of an electronic device according to various exemplary embodiments of the present disclosure.

Referring to FIG. 3, the electronic device may include a display of which a shape can be transformed. Examples of the electronic device include an electronic device equipped with a flexible display, an electronic device equipped with a plurality of foldable displays, and an electronic device equipped with a cover having a display protection function capable of a screen output. According to another exemplary embodiment, the electronic device may be an electronic device for outputting a screen to a display of another electronic device by using a wired or wireless communication mechanism.

In operation 301, the electronic device may confirm whether a transformation for the display is detected. The transformation for the display may a change in a shape or state (e.g., an open state, a close state) of the display. According to one exemplary embodiment, the electronic device may detect a transformation (e.g., increasing, decreasing, bending, folding-in, folding-out, twisting, curving, and the like) in a flexible display. According to other exemplary embodiment, the electronic device may detect folding-in, folding-out, or the like of a plurality of displays connected with one another through a connection portion. According to another exemplary embodiment, the electronic device may detect opening, closing, and the like of the cover having the display protection function capable of the screen output.

In operation 303, the electronic device may confirm display transformation information. According to one exemplary embodiment, the electronic device may control the output screen on the basis of the display transformation information. According to one exemplary embodiment, a display transformation point may be confirmed to determine a position and size of the output screen.

In operation 305, the electronic device may detect that the transformed display is restored to an original display shape. According to one exemplary embodiment, the electronic device may confirm that the transformed flexible display is restored or that a folded-in (or closed) display is folded out (or open).

In operation 307, the electronic device may confirm whether the transformation corresponds to a condition for the screen control on the basis of the transformation or restoration of the display. Herein, the screen control may include a size change of a screen which is output to the display, a size restoration of the changed screen, an output order change for a plurality of output screens, a sub screen output for the output screen, and the like.

According to one exemplary embodiment, the electronic device may determine whether to control the screen on the basis of transformation information during the restoration before the display is transformed. Upon detection of a transformation satisfying a pre-defined condition during the transformed display is restored to an original state, the electronic device may determine that it is a situation where the screen control is used.

According to an exemplary embodiment, the electronic device may confirm the transformation or restoration of the display and transformation information by using at least one or more sensor modules.

In operation 309, the electronic device may control the output screen according to the transformation information upon detection of a transformation corresponding to a condition for the screen control.

In operation 311, if the transformation corresponding to the condition for the screen control is not detected, the electronic device may maintain the current output screen.

Although the transformation and restoration of the display are described in FIG. 3 as an example for the transformation for the screen control, the present disclosure may control the output screen by using various transformations.

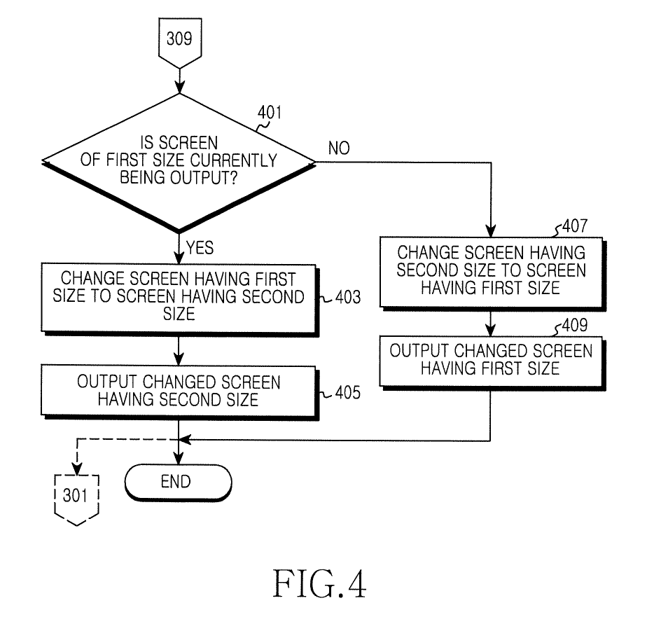

FIG. 4 illustrates a process of an output screen control operation of an electronic device according to various exemplary embodiments of the present disclosure.

Upon detection of a screen transformation for a screen control, for example, if a transformed display is restored to an original shape, the electronic device may adjust a size for an output screen in a state of determining that it is a situation where the screen control is used.

In operation 401, the electronic device may confirm a size of the output screen. The electronic device may confirm the size for the output screen at a time at which a transformation corresponding to a condition for the screen control is detected. According to one exemplary embodiment, the electronic device may output a screen corresponding to an entirety of a display area (for convenience of explanation, a screen having a first size) or may output a screen corresponding to a part of the display area (for convenience of explanation, a screen having a second size).

In operation 403, upon detection of the transformation corresponding to the condition for the screen control during the screen having the first size is output, the electronic device may change the currently output screen having the first size to the screen having the second size.

In operation 405, the electronic device may output the screen of which the size is changed to the second size to the display. According to one exemplary embodiment, the electronic device may determine an output position of the screen having the second size on the basis of a point at which the transformation is detected.

In operation 407, upon detection of the transformation corresponding to the condition for the screen control during the screen having the second size is output, the electronic device may change the currently output screen having the second size to the screen having the first size.

In operation 409, the electronic device may output the screen of which the size is changed to the first size to the display.

The electronic device according to various exemplary embodiments of the present disclosure may additionally perform the operation of FIG. 3 for detecting the transformation of the screen after adjusting the screen size on the basis of the transformation for the display.

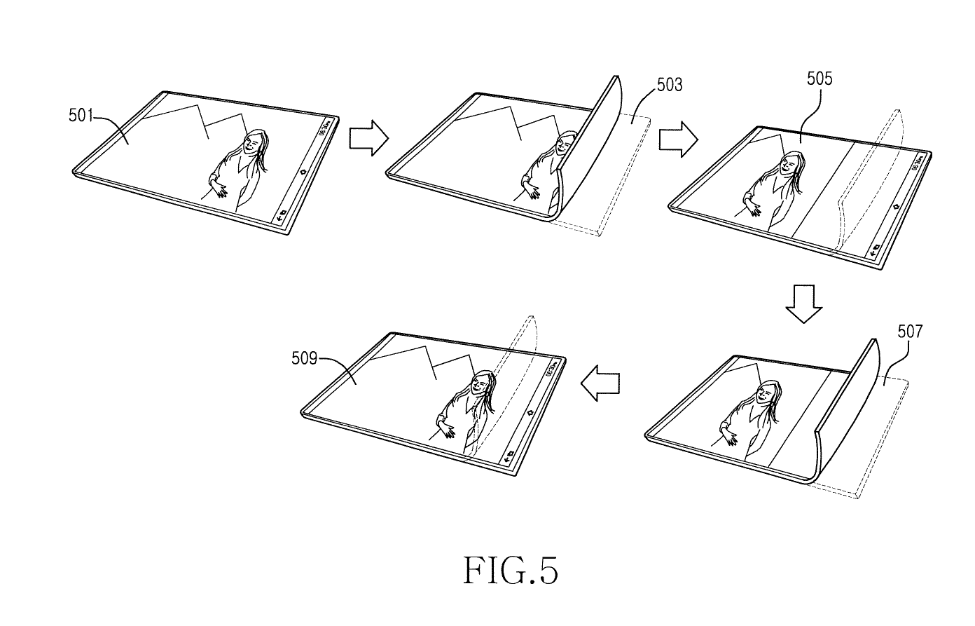

FIG. 5 illustrates an operation of controlling an output screen in an electronic device according to various exemplary embodiments of the present disclosure.

Referring to FIG. 5, the electronic device may change in a shape by an external force. According to one exemplary embodiment, the electronic device may be an electronic device consisting of a flexible display.

The electronic device according to the various exemplary embodiments of the present disclosure may control an output screen on the basis of a shape transformation (e.g., a screen transformation for a screen control). According to one exemplary embodiment, the electronic device may control the output screen on the basis of a shape maintained until a restoration is achieved after the transformation.

The electronic device may output a screen corresponding to an entirety of a display area (for convenience of explanation, a screen having a first size) or may output a screen corresponding to a part of the display area (for convenience of explanation, a screen having a second size).

As illustrate, upon detection of a transformation 503 in a state where a screen 501 having a first size is output, the electronic device may maintain the outputting of the screen having the first size.

If it is confirmed that the transformed shape is restored to an original shape, the electronic device may output the currently output screen having the first size to a screen 505 having a second size.

In the same manner, upon detection of a transformation 507 in a state where the screen having the second size is output, the electronic device may maintain the outputting of the screen having the second size.

If it is confirmed that the transformed shape is restored to an original shape, the electronic device may output the currently output screen having the second size to a screen 509 having the first size.

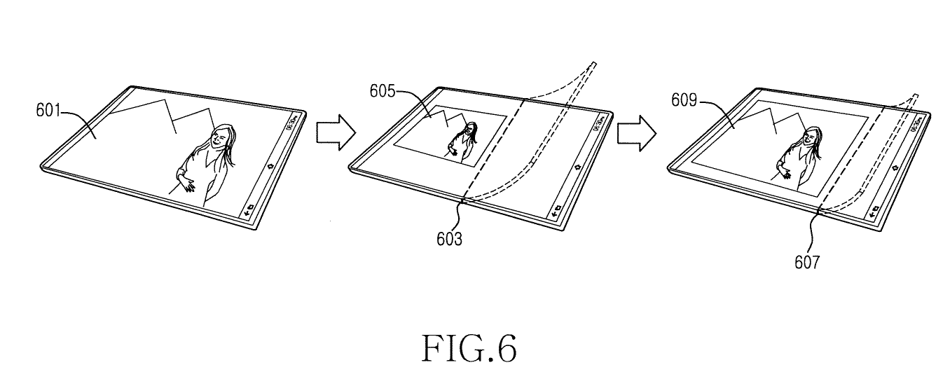

FIG. 6 illustrates an operation of controlling an output screen in an electronic device according to various exemplary embodiments of the present disclosure. In the description related to FIG. 6, identical or similar parts described in FIG. 5 will be omitted.

Referring to FIG. 6, an electronic device according to various exemplary embodiments of the present disclosure may control an output screen on the basis of a transformation point. According to one exemplary embodiment, the electronic device may adjust a size of an output screen on the basis of a point at which a transformation occurs.

According to one exemplary embodiment, the electronic device may define a left or right area of the transformation point as an output area, and may output a screen having a second size corresponding to a size of the output area.

As illustrated, the electronic device may display an output 605 by decreasing a screen 601 having a first size by 50% with respect to a transformation point 603, and may display an output 609 by decreasing the screen 601 having the first size by 30% with respect to a transformation point 607. In the drawing, the screen decreased by 30% may be a screen obtained in such a manner that the screen decreased by 50% is increased with respect to the transformation point.

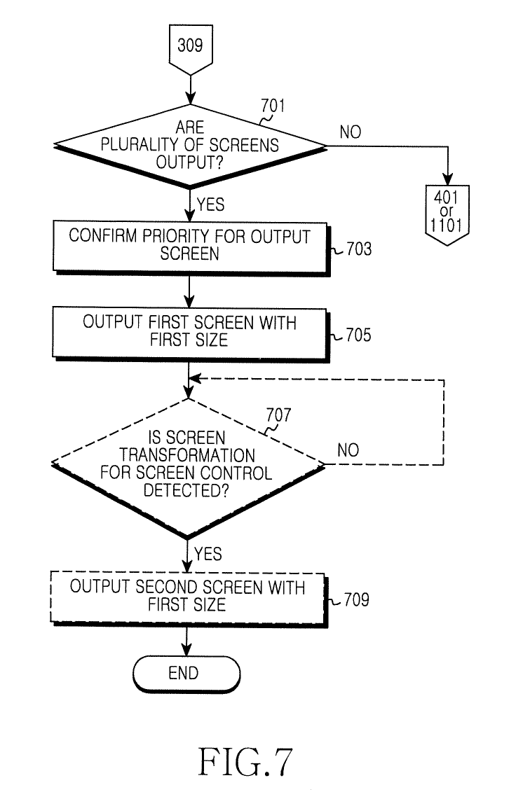

FIG. 7 illustrates a process of an output screen control operation of an electronic device according to various exemplary embodiments of the present disclosure.

The electronic device may change a screen output order after a transformed display is restored to an original shape in a state where a plurality of screens are output. According to one exemplary embodiment, the plurality of screens may be in a situation where a background screen and a popup screen are output.

In operation 701, the electronic device may confirm whether the plurality of screens are output. According to one exemplary embodiment, the plurality of screens may be execution screens for the same application or different applications. According to one exemplary embodiment, at least any one of the screens may be the background screen, the popup screen, and the like.

In operation 703, the electronic device may confirm a priority for the output screen. Herein, among the plurality of screens currently being output, an output order may be determined according to a predetermined size. According to one exemplary embodiment, the electronic device may confirm the priority for the output screen on the basis of an attribute or the like of a user input or output screen (e.g., an output order, a screen arrangement state (position)).

In operation 705, among the screens currently being output, the electronic device may output a screen satisfying a pre-defined condition (for convenience of explanation, a first screen) to a screen having a determined size (i.e., a screen having a first size). Of course, the electronic device may also output the screen satisfying the pre-defined condition to a screen having a second size.

According to one exemplary embodiment, the electronic device may output a screen selected by a user to a screen having a predetermined size. According to another exemplary embodiment, the electronic device may output a screen, which is last output before the display is transformed, to the screen having the predetermined size.

Additionally, in operation 707, the electronic device may confirm whether a screen transformation for a screen control is detected.

Additionally, in operation 709, upon detection of the screen transformation for the screen control, the electronic device may output a screen of a next priority (for convenience of explanation, a second screen) to the screen having the first size.

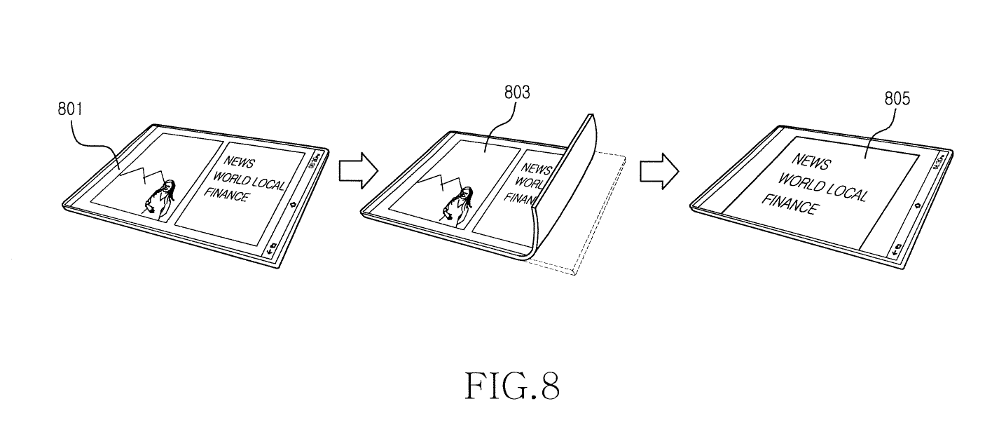

FIG. 8 illustrates an operation of controlling an output screen in an electronic device according to various exemplary embodiments of the present disclosure. In the description related to FIG. 8, identical or similar parts described in FIG. 5 will be omitted.

Referring to FIG. 8, an electronic device according to various exemplary embodiments of the present disclosure may change an output order for a plurality of screens on the basis of a shape transformation.

According to one exemplary embodiment, as illustrated, the electronic device may display an output 801 of a first screen (e.g., an image output screen) and a second screen (e.g., a web output screen). The electronic device may output the first screen and the second screen in the same size or different sizes. In addition, at least one screen may be output in a popup shape.

If it is detected that a transformed shape 803 is restored to an original shape, the electronic device may display an output 805 of a screen satisfying a pre-defined condition (e.g., a second screen) to a screen having a first size.

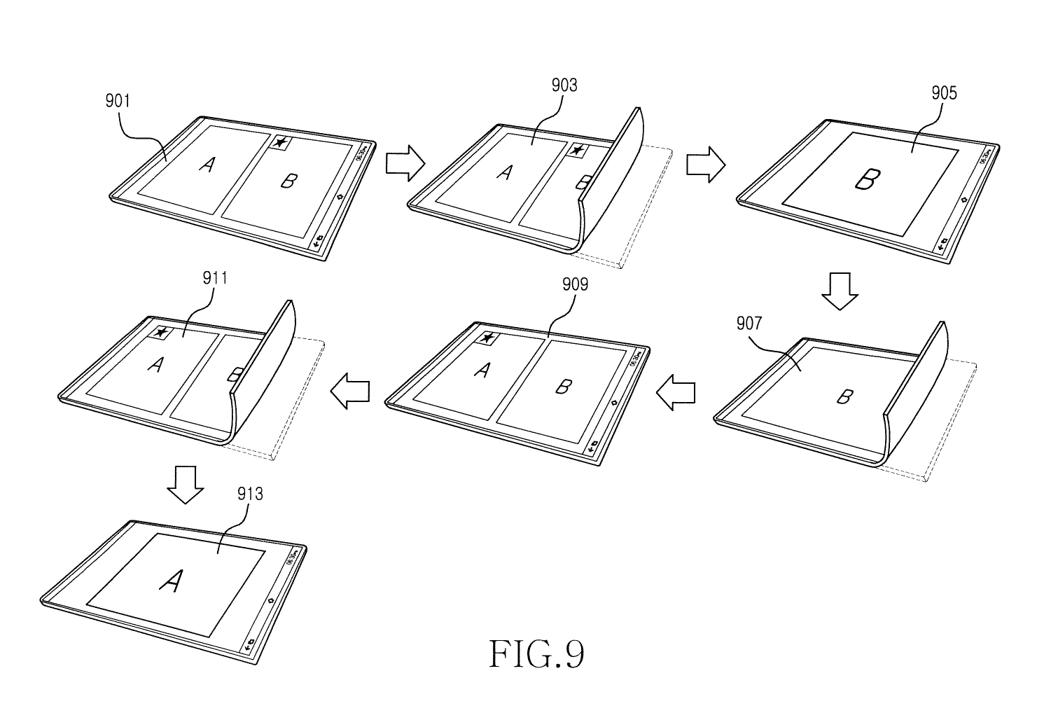

FIG. 9 illustrates an operation of controlling an output screen in an electronic device according to various exemplary embodiments of the present disclosure. In the description related to FIG. 9, identical or similar parts described in FIG. 5 will be omitted.

According to one exemplary embodiment, as illustrated, the electronic device may output a first screen (e.g., a screen A) and a second screen (e.g., a screen B). The electronic device may confirm an output priority for an output screen by detecting a user input.

As illustrated, the electronic device may display a mark 901 as information indicating that a priority is given to a screen selected by a user among output screens.

Upon detection of a transformation 903 in a state where the priority for the output screen is determined, the electronic device may maintain an output for the first screen and the second screen to which a priority is given.

If it is confirmed that the transformed shape is restored to an original shape, the electronic device may display an output 905 of a screen to which a priority is given to a screen having a first size.

In the same manner, upon detection of the transformation in the state where the screen to which the priority is given is output, the electronic device may maintain an output 907 of the screen to which the priority is given.

If it is confirmed that the transformed shape is restored to the original shape, the electronic device may display an output 909 of the first screen and the second screen, and may change an output priority for an output screen by detecting a user input. In the drawing illustrated, it is shown a situation in which a priority given to the second screen is given to the first screen by the user input.

Upon detection of a transformation 911 in a state where a priority is determined for an output screen, the electronic device may maintain an output for the first and second screens to which the priority is given.

If it is confirmed that the transformed shape is restored to the original shape, the electronic device may display an output 913 of the screen to which the priority is given to the screen having the first size.

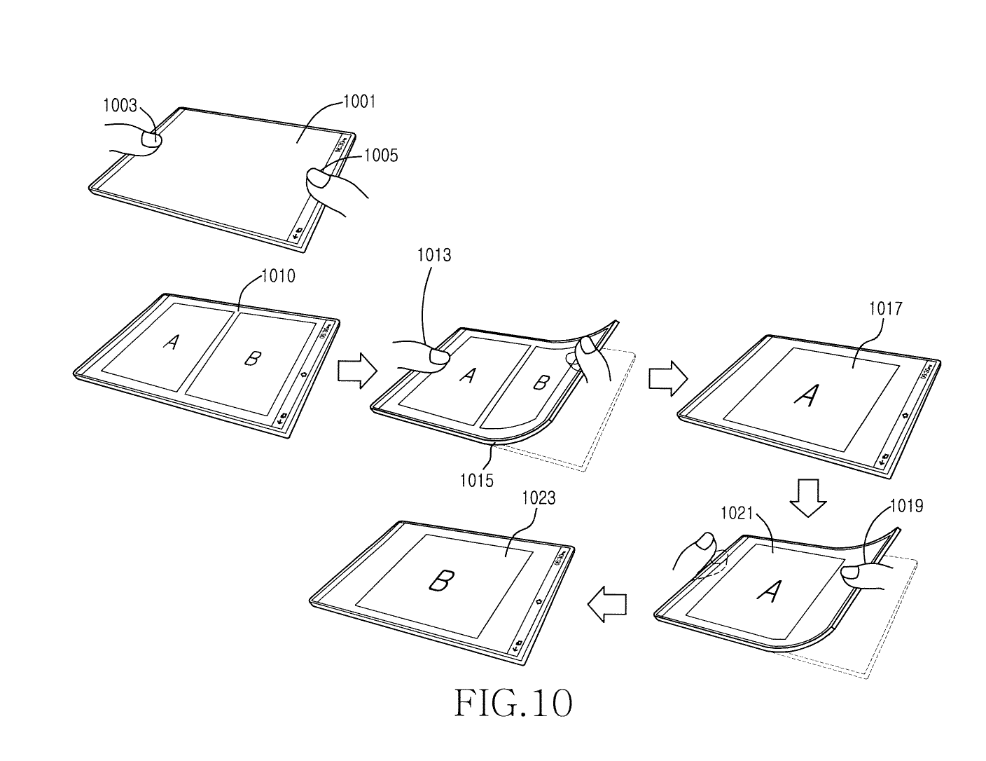

FIG. 10 illustrates an operation of controlling an output screen in an electronic device according to various exemplary embodiments of the present disclosure. In the description related to FIG. 10, identical or similar parts described in FIG. 5 will be omitted.

According to one exemplary embodiment, an electronic device 1001 may output a first screen (e.g., a screen A) and a second screen (e.g., a screen B), and may define an area for selecting the first screen and an area for selecting the second screen as to a part of the screen. According to one exemplary embodiment, as illustrated, the electronic device may define a part of a left side 1003 and right side 1005 of the screen as an area for selecting the screen.

Upon detection of a transformation and restoration satisfying a screen control condition, the electronic device may confirm an input for selecting a screen.

As illustrated, if an electronic device which displays an output 1010 of a first screen (e.g., a screen A) and a second screen (e.g., a screen B) detects a transformation 1015 and a restoration are detected in a state where an input 1013 for selecting the first screen is detected, the first screen corresponding to an input may be displayed as an output 1017 to a screen having a first size.

In the same manner, upon detection of a transformation 1021 and a restoration in a state where a detection 1019 is made on an input for selecting the second screen, the second screen corresponding to an input may be displayed as an output 1023 to the screen having the first size.

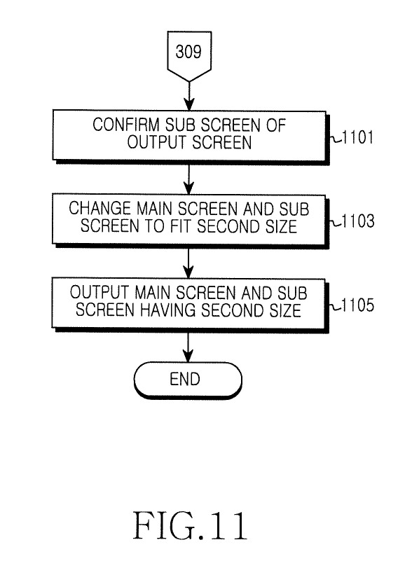

FIG. 11 illustrates a process of a screen control operation of an electronic device according to various exemplary embodiments of the present disclosure.

Upon detection of a screen transformation for a screen control, for example, a transformation in which a transformed display is restored to an original shape, the electronic device may output a sub screen for an output screen in a state where it is detected that the screen control is necessary.

In operation 1101, the electronic device may output the sub screen for the output screen. Herein, the sub screen may be screens that can be switched from the output screen. For example, for a telephony application, the sub screen may consist of a dial screen, a recent history screen, a bookmark screen, a contact information screen, and the like, and a slave screen for the dial screen may be a recent history screen, a favorite screen, a contact information screen, and the like, which can be switched from the dial screen.

In operation 1103, the electronic device may change the main screen and the sub screen to fit a second size. The electronic device may change the main screen and the sub screen to fit not the first size but the second size such that the main screen and the sub screen can be output together.

In operation 1105, the electronic device may output the main screen and the sub screen which are changed to fit the second size.

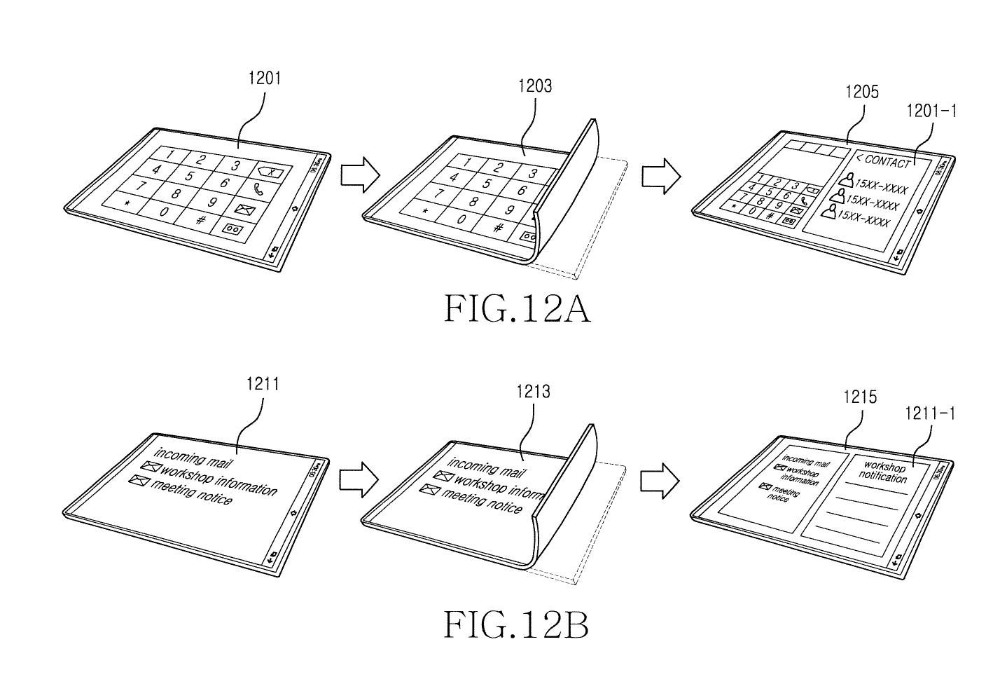

FIG. 12A-12B illustrate operations of controlling an output screen in an electronic device according to various exemplary embodiments of the present disclosure. In the description related to FIG. 12A-12B, identical or similar parts described in FIG. 5 will be omitted.

According to one exemplary embodiment, upon detection of a transformation in a state where a main screen is output, the electronic device may output a sub screen with respect to the main screen.

Referring to FIG. 12A, upon detection of a transformation 1203 in a state where an output 1201 of a telephony application screen is displayed, an output for the telephony application screen may be maintained.

If a restoration 1205 in which the transformed shape is restored to an original shape is confirmed, the electronic device may output a sub screen 1201-1 for the telephony application screen, for example, a recent history screen, a favorite screen, a contact information screen, and the like, together with the main screen.

In a state where the sub screen is output, if it is detected that a shape is restored after transformation, the electronic device may stop outputting of the sub screen.

According to various exemplary embodiments, as shown in FIG. 12B, upon detection of a transformation 1213 in a state where an output 1211 of an e-mail application screen is displayed, an output for the e-mail application screen, for example, an output for an incoming mail list screen may be maintained.

If a restoration 1215 in which the transformed shape is restored to the original shape is confirmed, the electronic device may output a sub screen 1211-1 for the e-mail application screen, for example, an incoming e-mail content, together with the main screen.

According to various exemplary embodiments, the electronic device may define a sub screen to be displayed on the basis of a transformation degree of the electronic device. According to one exemplary embodiment, a first sub screen for the main screen may be output as to a first transformation degree, and a second sub screen may be output for the main screen as to a second transformation degree.

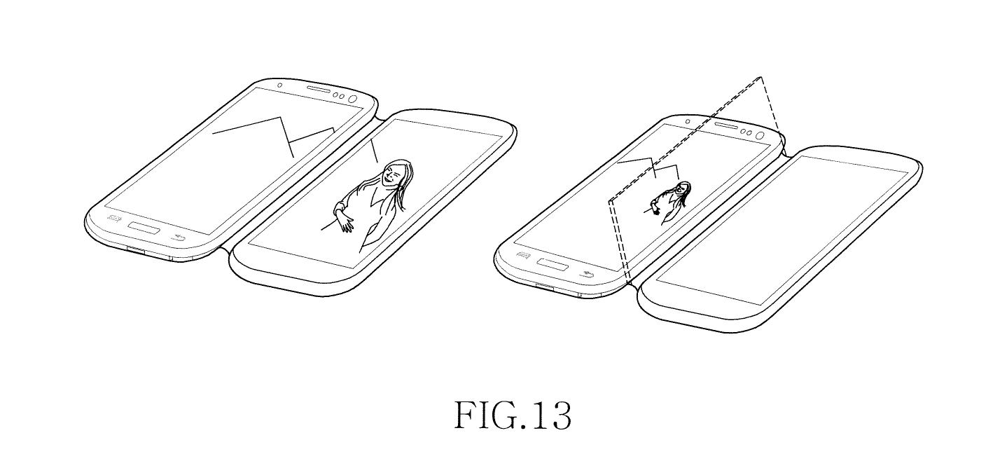

FIG. 13 illustrates an electronic device according to various exemplary embodiments of the present disclosure.

According to various exemplary embodiments of the present disclosure, an output screen may be controlled on the basis of a screen transformation for a screen control of the electronic device, for example, a display transformation and restoration. According to one exemplary embodiment, the electronic device may detect a transformation and restoration for a flexible display.

According to another exemplary embodiment, as illustrated, the electronic device may have a plurality of displays, and may control an output screen by detecting a position for at least any one display. According to one exemplary embodiment, the electronic device may adjust a size of the output screen when at least one display is open after being closed among the plurality of displays.

According to various exemplary embodiments, a screen output method performed in an electronic device may include detecting a transformation of the electronic device, and if the transformation satisfies a pre-defined condition, controlling an output screen.

According to various exemplary embodiments, the controlling of the output screen may include at least one of operations of changing a size of the output screen, changing an output position, and changing an output order.

According to various exemplary embodiments, the controlling of the output screen may include outputting a sub screen constituting the output screen.

According to various exemplary embodiments, the method may further include confirming a transformation position of the electronic device. The controlling of the output screen may include controlling the output screen on the basis of a transformation position of the electronic device.

According to various exemplary embodiments, the detecting of the transformation of the electronic device may include detecting a transformation and restoration of the display.

According to various exemplary embodiments, the transforming of the electronic device may include transforming a flexible display or transforming a plurality of displays connected through a connection portion.

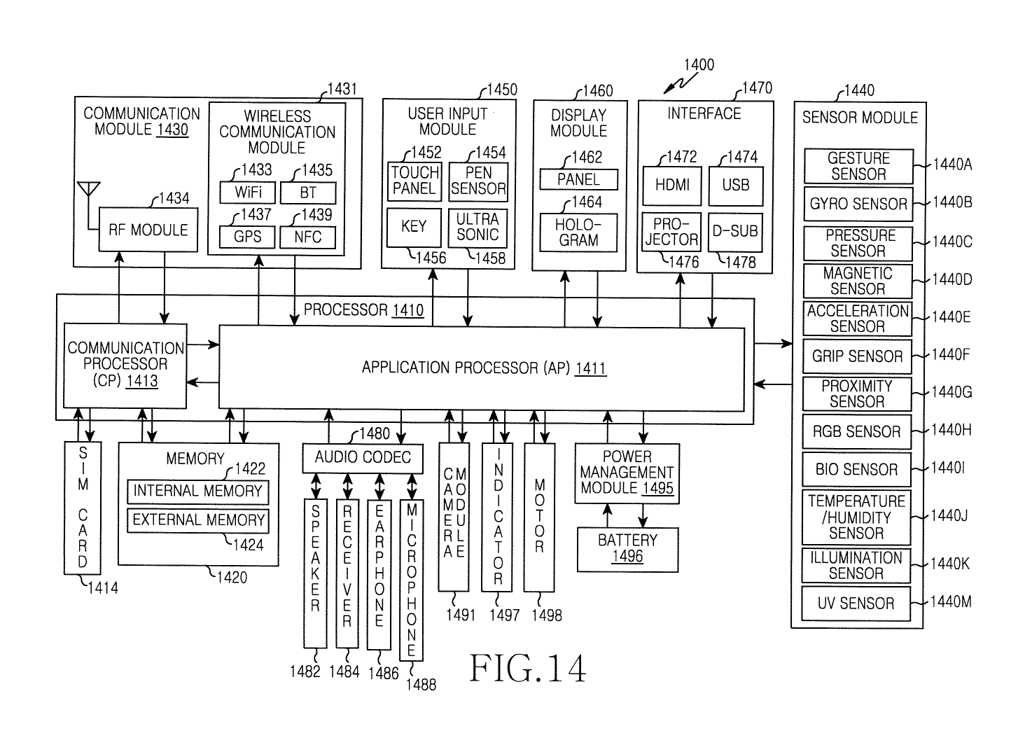

FIG. 14 is a block diagram of an electronic device 1400 according to an exemplary embodiment of the present disclosure. The electronic device 1400 may be, for example, the electronic device 100 of FIG. 1. Referring to FIG. 14, the electronic device 1400 may include one or more processors 1410, a Subscriber Identity Module (SIM) card 1414, a memory 1420, a communication module 1430, a sensor module 1440, a user input module ,1450, a display module 1460, an interface 1470, an audio codec 1480, a camera module 1491, a power management module 1495, a battery 1496, an indicator 1497, and a motor 1498.

The processor 1410 (e.g., the processor 120) may include one or more Application Processor (APs) 1411 and one or more Communication Processors (CPs) 1413. While the AP 1411 and the CP 1413 are included in the processor 1410 of FIG. 14, the AP 1411 and the CP 1413 may be included in different Integrated Circuit (IC) packages. The AP 1411 and the CP 1413 may be included in the single IC package.

The AP 1411 may control hardware or software components connected to the AP 1411 by driving an operating system or an application program, and carry out data processing and operations including multimedia data. The AP 1411 may be implemented using, for example, a System on Chip (SoC). The processor 1410 may further include a Graphic Processing Unit (GPU) (not shown).

The CP 1413 may manage data links and convert the communication protocol in the communications between the electronic device 1400 and the other electronic devices connected over the network. The CP 1413 may be implemented using, for example, a SoC. The CP 1413 may perform at least part of a multimedia control function. The CP 1413 may identify and authenticate the electronic device in the communication network using the SIM card 1414. The CP 1413 may provide the user with services including voice call, video call, text message, and packet data.

The CP 1413 may control the data transmission and reception of the communication module 1430. While the components of the CP 1413, the power management module 1495, and the memory 1420 are separated from the AP 1411 in FIG. 14, the AP 1411 may include part (e.g., the CP 1413) of such components.

The CP 1413 may be the processor 120 of FIG. 1.

The AP 1411 or the CP 1413 may load and process the instruction or the data received from at least one of its non-volatile memory and the other component, in a volatile memory. The 1411 AP or the CP 1413 may store data received from or generated by at least one of the other components, to the non-volatile memory.

The SIM card 1414 may be inserted to a slot formed at a specific location of the electronic device. The SIM card 1414 may contain unique identification information (e.g., Integrated Circuit Card Identifier (ICCID)) or subscriber information (e.g., International Mobile Subscriber Identity (IMSI)).

The memory 1420 may include an internal memory 1422 and an external memory 1424. The memory 1420 may be, for example, the memory 130 of FIG. 1. The internal memory 1422 may include at least one of, for example, the volatile memory (e.g., Dynamic Random Access Memory (DRAM), Static RAM (SRAM), Synchronous DRAM (SDRAM)) and the non-volatile memory (e.g., One-Time Programmable Read Only Memory (OTPROM), Programmable ROM (PROM), Erasable PROM (EPROM), Electrically EPROM (EEPROM), mask ROM, flash ROM, NAND flash memory, NOR flash memory). The internal memory 1422 may employ a Solid State Drive (SSD). The external memory 1424 may further include, for example, a Compact Flash (CF), a Secure Digital (SD), a Micro-SD, a Mini-SD, an extreme digital (xD), and a memory stick.

The communication module 1430 may include a wireless communication module 1431 and a Radio Frequency (RF) module 1434. For example, the communication module 1430 may be the communication module 160 of FIG. 1. For example, the wireless communication module 1431 may include a Wi-Fi 1433, a BT 1435, a GPS 1437, and an NFC 1439. For example, the wireless communication module 1431 may provide a wireless communication function using a radio frequency. Additionally/substantially, the wireless communication module 1431 may include a network interface (e.g., LAN card) or a modem for connecting the electronic device 1400 to the network (e.g., Internet, LAN, WAN, telecommunication network, cellular network, satellite network, or POTS).

The RF module 1434 may control the data transmission and reception, for example, the transmission and reception of the RF signal or the paged electric signal. For example, the RF module 1434 may include a transceiver, a Pulse Amplitude Module (PAM), a frequency filter, or a Low Noise Amplifier (LNA) which are not shown. The RF module 1434 may further include a component, for example, conductor or conducting wire, for sending and receiving electromagnetic waves in free space during the wireless communication.

The sensor module 1440 may include at least one of, for example, a gesture sensor 1440A, a gyro sensor 1440B, an atmospheric pressure sensor 1440C, a magnetic sensor 1440D, an acceleration sensor 1440E, a grip sensor 1440F, a proximity sensor 1440G, a Red Green Blue (RGB) sensor 1440H, a biometric sensor 1440I, a temperature/humidity sensor 1440J, a light sensor 1440K, and an UltraViolet (UV) sensor 1440M. The sensor module 1440 may measure a physical quantity or detect the operation status of the electronic device, and convert the measured or detected information to an electric signal. Additionally/substantially, the sensor module 1440 may include, for example, an E-noise sensor (not shown), an electromyography (EMG) sensor (not shown), an electroencephalogram (EEG) sensor (not shown), an electrocardiogram (ECG) sensor (not shown), or a finger print sensor. The sensor module 1440 may further include a control circuit for controlling its one or more sensors.

The user input module 1450 may include a touch panel 1452, a (digital) pen sensor 1454, a key 1456, and an ultrasonic input device 1458. For example, the touch panel 1452 may recognize the touch input using at least one of capacitive, resistive, infrared, and Surface Acoustic Wave (SAW) techniques. The touch panel 1452 may further include a controller (not shown). The capacitive touch panel may recognize not only the direct touch but also the proximity. The touch panel 1452 may further include a tactile layer. In this embodiment, the touch panel 1452 may provide a tactile response to the user.

The (digital) pen sensor 1454 may be implemented using, for example, the same or similar method as or to the user's touch input, or using a separate recognition sheet. For example, the key 1456 may include a keypad or a touch key. The ultrasonic input device 1458, which obtains data by detecting microwave through a microphone 1488 in the electronic device, allows radio frequency identification through the pen which generates an ultrasonic signal. The electronic device 1400 may receive the user input from an external device (e.g., a network, a computer, a server) connected using the communication module 1430.

The display module 1460 may include a panel 1462 or a hologram 1464. The panel 1462 may employ, for example, a Liquid Crystal Display (LCD) or an Active Matrix Organic Light Emitting Diode (AMOLED). The panel 1462 may be implemented, for example, flexibly, transparently, or wearably. The panel 1462 may be constructed as the single module with the touch panel 1452. The hologram 1464 may present a three-dimensional image in the air using interference of light. The display module 1460 may further include a control circuit for controlling the panel 1462 or the hologram 1464.

The interface 1470 may include, for example, a High Definition Multimedia Interface (HDMI) 1472, a Universal Serial Bus (USB) 1474, a projector 1476, and a D-subminiature (D-sub) 1478. Additionally/substantially, the interface 1470 may include, for example, a SD/Multi-Media Card (MMC) or Infrared Data Association (IrDA), which are not shown.

The audio codec 1480 may convert the voice to an electric signal and vice versa. For example, the audio codec 1480 may convert voice information which is input or output through, for example, a speaker 1482, a receiver 1484, an earphone 1486, or the microphone 1488.

The camera module 1491 may capture a still picture and a moving picture, and may include one or more image sensors (e.g., front lens or rear lens), an Image Signal Processor (ISP) (not shown), or a flash LED (not shown).

The power management module 1495 may manage power of the electronic device 1400. For example, the power management module 1495 may include a Power Management IC (PMIC), a charger IC, or a battery fuel gauge which is not shown.

The PMIC may be mounted in, for example, an IC or a SoC conductor. The charging type may be divided to a wired type and a wireless type. The charger IC may charge the battery and prevent overvoltage or overcurrent from flowing from the charger. The charger IC may include a charger IC for at least one of the wired charging type or the wireless charging type. The wireless charging type includes, for example, magnetic resonance, magnetic induction, and microwave, and may further include an additional circuit, for example, coil loop, resonance circuit, rectifier circuit, for the wireless charging.

The battery fuel gauge may measure, for example, the remaining capacity of the battery 1496 and the voltage, the current, or the temperature of the charging. The battery 1496 may supply the power by generating the electricity. For example, the battery 1496 may be a rechargeable battery.

The indicator 1497 may display a specific status, for example, booting state, message state, or charging state of the hardware 1400 or part (e.g., AP 1411) of the hardware 1400. The motor 1498 may convert the electric signal to a mechanic vibration.

Although it is not depicted here, the electronic device 1400 may further include a processor (e.g., GPU) for supporting mobile TV. For example, the processor for supporting the mobile TV may process media data in conformity with Digital Multimedia Broadcasting (DMB), Digital Video Broadcasting (DVB), or media flow standard. The aforementioned hardware components may include one or more components, and the names of the corresponding components of the present disclosure may differ according to the type of the electronic device. The hardware of the present disclosure may include at least one of the components, omit some components, or further include other components. Some of the hardware components may be united to the single entity to carry out the same functions of the corresponding components.

Each of the aforementioned constitutional elements of the electronic device according to the present disclosure may consist of one or more components, and names thereof may vary depending on a type of electronic device. The electronic device according to the present disclosure may include at least one of the aforementioned constitutional elements. Some of the constitutional elements may be omitted, or additional other constitutional elements may be further included. In addition, some of the constitutional elements of the electronic device according to the present disclosure may be combined and constructed as one entity, so as to equally perform functions of corresponding constitutional elements before combination.

A term “module” used in the present disclosure may imply a unit including, for example, one of hardware, software, and firmware or a combination of two or more of them. The “module” may be interchangeably used with a term such as a unit, logic, a logical block, a component, a circuit, and the like. The “module” may be a minimum unit of an integrally constituted component or may be a part thereof. The “module” may be a minimum unit for performing one or more functions or may be a part thereof. The “module” may be mechanically or electrically implemented. For example, the “module” of the present disclosure may include at least one of an Application-Specific Integrated Circuit (ASIC) chip, a Field-Programmable Gate Arrays (FPGAs), and a programmable-logic device, which are known or will be developed and which perform certain operations.

According to various exemplary embodiments, at least some parts of a device (e.g., modules or functions thereof) or method (e.g., operations) of the present disclosure may be implemented with an instruction stored in a computer-readable storage media for example. If the instruction is executed by one or more processors (e.g., the processor 120), the one or more processors may perform a function corresponding to the instruction. The computer-readable storage media may be, for example, the memory 130. At least some parts of the programming module may be implemented (e.g., executed), for example, by the processor 120. At least some parts of the programming module may include modules, programs, routines, sets of instructions, processes, and the like, for performing one or more functions.

The computer readable recording medium may be a hardware device configured particularly to store and perform a program instruction (e.g., program module), for example, a hard disk, a magnetic medium such as a floppy disc and a magnetic tape, an optical storage medium such as a Compact Disc-ROM (CD-ROM) or a Digital Versatile Disc (DVD), a magnetic-optic medium such as a floptical disc, a Read Only Memory (ROM), a Random Access Memory (RAM), a flash memory, and the like. An example of the program instruction includes not only a machine language created by a compiler but also a high-level language executable by a computer by using an interpreter or the like. The aforementioned hardware device may be configured to operate as one or more software modules to perform the operation of the present disclosure, and the other way around is also possible.

The module or programming module according to the present disclosure may further include at least one or more constitutional elements among the aforementioned constitutional elements, or may omit some of them, or may further include additional other constitutional elements. Operations performed by a module, programming module, or other constitutional elements of the present disclosure may be executed in a sequential, parallel, repetitive, or heuristic manner. In addition, some of the operations may be executed in a different order or may be omitted, or other operations may be added.

According to various exemplary embodiments, in a storage medium having instructions stored therein, when the instructions are executed by at least one processor, the processor is configured to perform at least one operation. The at least one operation may include an operation of detecting a screen transformation of the electronic device, and if the change satisfies a pre-defined condition, may include at least one of operations of changing a size of an output screen, changing an output position, and changing an output order.

An electronic device according to various exemplary embodiments of the present disclosure may control an output screen without having to generate an input for a window control, by detecting a screen transformation for a screen control of the electronic device, for example, by detecting that a display is transformed and thereafter is restored to an original shape.

While the present disclosure has been shown and described with reference to certain embodiments thereof, it will be understood by those skilled in the art that various changes in form and details may be made therein without departing from the spirit and scope of the disclosure as defined by the appended claims. Therefore, the scope of the present disclosure is defined not by the detailed description of the present disclosure but by the appended claims, and all differences within the scope will be construed as being included in the present disclosure.

What is claimed is:

1. A method performed in an electronic device, the method comprising:
detecting a transformation of the electronic device; and
if the transformation satisfies a pre-defined condition, controlling an output screen.

2. The method of claim 1, wherein the controlling of the output screen comprises at least one of changing a size of the output screen, changing an output position, and changing an output order.

3. The method of claim 1, wherein the controlling of the output screen comprises outputting a sub screen constituting the output screen.

4. The method of claim 1, further comprising:
confirming a transformation position of the electronic device, wherein the controlling of the output screen comprises controlling the output screen on the basis of a transformation position of the electronic device.

5. The method of claim 1, wherein the transforming of the electronic device comprises transforming a display and thereafter restoring the display.

6. The method of claim 5, wherein the transforming of the electronic device comprises transforming a flexible display or transforming a plurality of displays connected through a connection portion.

7. An electronic device comprising:
a display unit configured to output a screen;
a transformation detection module configured to detect a screen transformation for a screen control of the electronic device; and
at least one processor,
wherein the processor is configured to, upon detection of the screen transformation for the screen control of the electronic device in a state where a screen comprising a first size is output, output the previously output screen comprising the first size by changing the screen size from the first size to a second size.

8. The electronic device of claim 7, wherein the processor is configured to, upon detection of the screen transformation for the screen control of the electronic device in a state where the screen of which a size is changed to the second size is output, output the previously output screen comprising the second size by changing the screen size to the first size.

9. The electronic device of claim 7, wherein the processor is configured to, upon detection of the screen transformation for the screen control of the electronic device in a state where a plurality of screens are output, confirm a priority for an output screen, and change a size of a screen corresponding to the priority.

10. The electronic device of claim 9, wherein the processor is configured to confirm at least one of a user input, a screen output order, and a screen arrangement state (position) as the priority.

11. The electronic device of claim 7, wherein the transformation detection module is configured to detect the screen transformation for the screen control of the electronic device on the basis of at least one of a transformation point and a transformation degree.

12. The electronic device of claim 7, wherein the processor is configured to output a sub screen constituting an output screen after changing a size of the screen.

13. The electronic device of claim 7,
wherein the display unit comprises a flexible display, and
wherein the transformation detection module is configured to detect a transformation of the flexible display for the screen control.

14. The electronic device of claim 7,
wherein the display unit comprises a plurality of displays connected through a connection portion, and
wherein the transformation detection module is configured to detect a movement for the display.

15. A non-transitory computer readable medium comprising program code that, when executed by at least one processor, causes an electronic device to:
detect a screen transformation of an electronic device; and if the transformation satisfies a pre-defined condition, control an output screen.

16. The non-transitory computer readable medium of claim 15, wherein the controlling of the output screen comprises at least one of operations of changing a size of the output screen, changing an output position, and changing an output order.

17. The non-transitory computer readable medium of claim 15, wherein the controlling of the output screen comprises outputting a sub screen constituting the output screen.

18. The non-transitory computer readable medium of claim 15, further comprising program code that, when executed by at least one processor, causes an electronic device to:
confirm a transformation position of the electronic device, wherein the controlling of the output screen comprises controlling the output screen on the basis of a transformation position of the electronic device.

19. The non-transitory computer readable medium of claim 15, wherein the transforming of the electronic device comprises transforming a display and thereafter restoring the display.

20. The non-transitory computer readable medium of claim 19, wherein the transforming of the electronic device comprises transforming a flexible display or transforming a plurality of displays connected through a connection portion.
